(19) United States
(12) Patent Application Publication
(10) Pub. No.: US 2005/0195085 A1
(43) Pub. Date: Sep. 8, 2005

(54) Wireless monitoring system of diaper wetness, motion, temperature and sound

(76) Inventor: Eugen Cretu-Petra, Northville, MI (US)

Correspondence Address: Eugen Cretu-Petra, Suite 2, 18547 Innsbrook Dr., Northville, MI, 48167, US

(21) Appl. No.: 10/791,409

(22) Filed: Mar. 2, 2004

(51) Int. Cl. G08B 23/00

(52) U.S. Cl. 340/573.5; 340/604

(57) ABSTRACT

A self-contained, reusable sensing device attached to a diaper, comprising conductivity sensors (S1, S2, S3 and S4), a capacitive sensor (CS), a motion sensor (MS), a microphone (MIC) and a temperature sensor (TS). The output of each said sensors is analyzed by a microcontroller(MC1). Said microcontroller output enters a wireless transmitter, which relays to a remotely monitored pager. Pager display shows visually and by sound the stream of data coming from said pager wireless receiver.

### BACKGROUND OF THE INVENTION

1. Background-Field of the Invention

This invention relates to a self-contained, reusable sensing device with a diaper for:
Separately determine urine or feces presence in said diaper;
Distinction between urine and feces in said diaper;
Fullness level of urine and feces in said diaper;
Diaper wearer motion;
Diaper wearer sound;
Diaper wearer body temperature.

And a wireless transmitter for relaying said conditions to a remotely monitored device.

2. Background-Description of the Prior Art

All infants up to 2 years old need diapers. 30% of the patients in care facilities such as hospitals and nursing homes or even in homes are bed-ridden or otherwise incontinent. Most important cause of diaper rash is because of too long feces and/or urine contact with diaper wearer skin. Of these two, more important is the feces contact with the skin. In order to prevent skin irritation the diaper must be changed as soon as possible after bowel movement or urination occurred. Today's infant diapers absorb more than one urination. They contain a special gel, which absorbs, hold and, up to a certain point, do not allow germs development. Feces absorb in diapers only partially and develop germs more quickly, becoming a cause of skin irritation. For parents or attendants it is most important to know when a diaper wearer bowel movement occurs or when the diaper is full. For parents or attendants is important to know when diaper wearers wake up and start to move or cry after sleep, or if they did not move at all for a while. For parents or attendants is important to know when diaper wearer body temperature becomes abnormal.

Existent electrical or electronic alarm devices signal just diaper wetness condition; no matter there is urination or feces. They do not detect separately diaper wearer bowel movement or urination. They do not sense and show the level of diaper fullness. They do not sense and show the diaper wearer motion. They do not sense and show the diaper wearer sounds and sound amplitude level. They do not monitor diaper wearer body temperature. That is why they are not used today for infants and they are used on a small scale only in some senior facilities and some hospitals.

### OBJECTS AND ADVANTAGES

The object of this invention is to provide a self contained, reusable sensing device for:
Separately determine urine or feces presence in a diaper;
Distinction between urine and feces in said diaper;
Urine and feces level of fullness in said diaper;
Diaper wearer motion;
Diaper wearer sound;
Diaper wearer body temperature.

Said sensing device can be used with any paper or cloth diaper in a home or in a health care facility. Once a wet diaper is detected and changed by an attendant, said device is removed and transferred to a dry, clean diaper.

A further object of the present invention is to provide a sensing device for said diaper conditions and transmitting these conditions automatically, wireless to a remotely located attendant.

A further object of this invention is to provide a system for remotely monitoring said conditions of a plurality of diapers. Such a system comprises a plurality of said sensing devices, affixed on said plurality of diapers, each being electronically encoded with a unique address and having an output coupled to a transmitter for transmitting said conditions and said addresses. The system further contains at least a receiver for receiving said conditions and said addresses.

A further object of this invention is to provide a wireless device with display, which provides for an attendant data about said diaper conditions.

Other objects, features and advantages will become more apparent upon reading of the detailed description and drawings of the preferred embodiment of the present invention.

### DRAWING FIGURES

FIG. 1 is a perspective view of diaper with a detector affixed on it;

FIG. 2 is a perspective view of the detector—the against the diaper side upfront;

FIG. 3 is a section view of a detector affixed on a diaper;

FIG. 4 is a detailed section view of a retracted claw;

FIG. 5 is a detailed section view of a penetrated through the diaper claw;

FIG. 6 is a longitudinal section view of the detector;

FIG. 7 is a front view of the detector, showing the mechanics of the detector;

FIG. 8 is a system block diagram of preferred embodiment of the present invention;

FIG. 9 is a perspective view of a diaper with both a temperature sensor and a detector attached on it;

FIG. 10 is a front view of a pager display;

FIG. 11 is a section view of a diaper support with a diaper and a detector on top of it.

### DETAILED DESCRIPTION

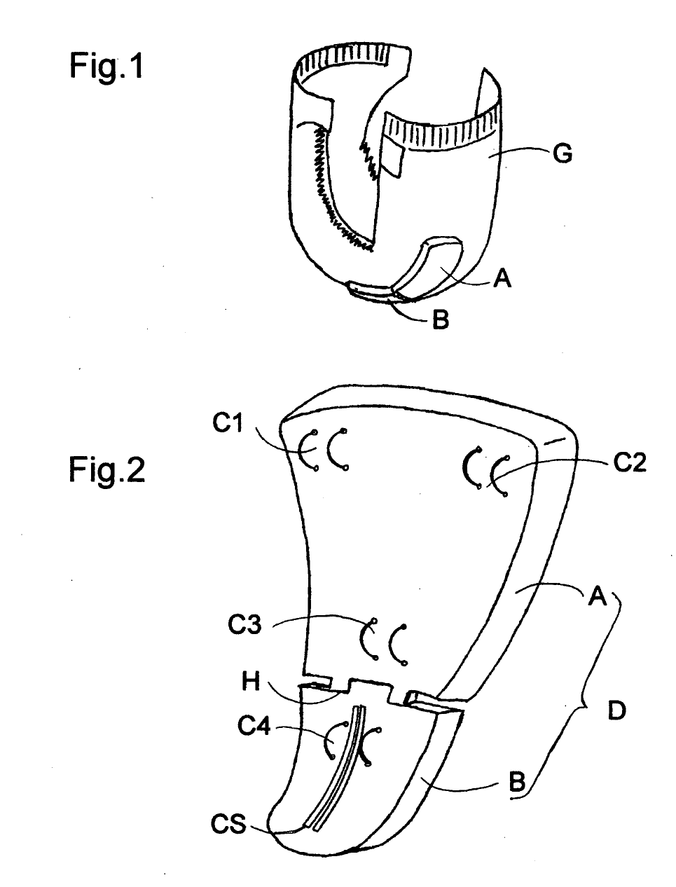

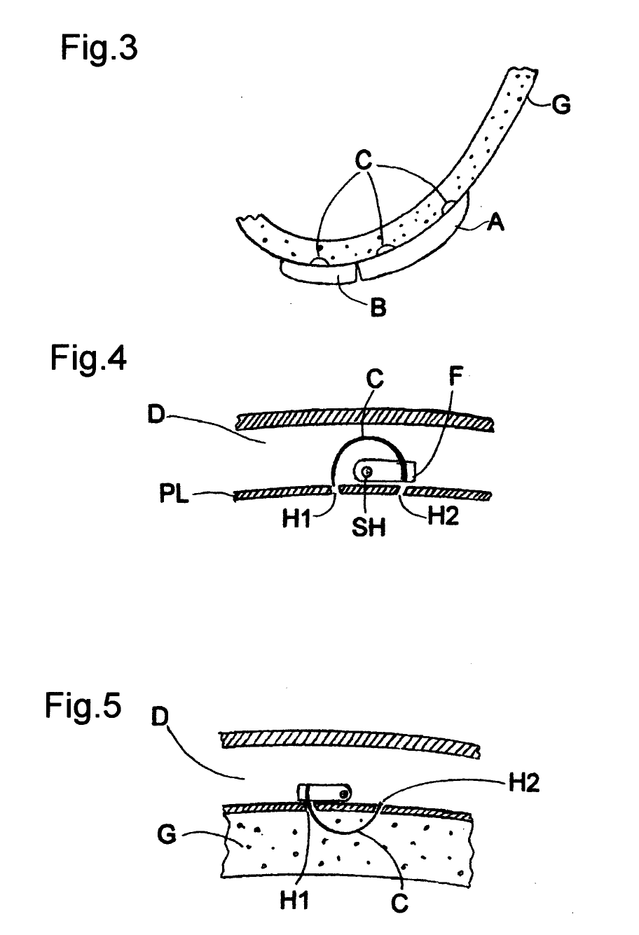

Referring to FIG. 1, FIG. 2 and FIG. 3, paper or cloth diaper G has affixed on it a detachable sensing device D, named also detector D. Said detector D has two parts A and B, united by a hinge H. Rounded shape of said parts A and B and said hinge allow detector D to stay in full contact with diaper G, in order to be comfortable and to allow a proper detection at capacitive sensor CS. On the side of said detector D, which stays in contact with diaper G, are the retractable pairs of claws C1 . . . C4. Each said pair has two claws C. Said pairs of claws have two functions. One function is to affix the detector D on the diaper. Second function is each pair of claws C1 . . . C4 serves as electrodes for conductive sensors S1 . . . S4. They measure conductivity between two claws of each pair C1 . . . C4. On the center of part B is a capacitive sensor CS. Said sensor has two parallel plates having the shape as in FIG. 2. Sensors S1 . . . S3 are urine sensors. Sensors S4 and CS are feces sensors. There are two feces sensors of two kinds in order to be sure that at least one of them are activated when a bowel movement occurs. The explanation is that sometime feces are in liquid form and some times they have a bigger viscosity. The liquid feces activate easier the conductive type sensor. The more viscous feces activate easier the capacitive type sensor.

Referring to FIG. 4 and FIG. 5 a claw C is fixed within part F. Part F is made of nonconductive plastic material. Part F is fixed to the other end on shaft SH. Said assemble which contains claw C, part F and shaft SH is incased in the case of said detector D. The plate PL is a part of detector D housing. Said plate PL has two holes H1 and H2 for each claw C. Detector D is affixed on the diaper G with plate PL in full contact with diaper G. When shaft SH rotates an angle of about 150 degrees in counter clock direction, claw C exits detector D housing through hole H1 and goes through diaper G. In the end of its course claw C enters hole H2.

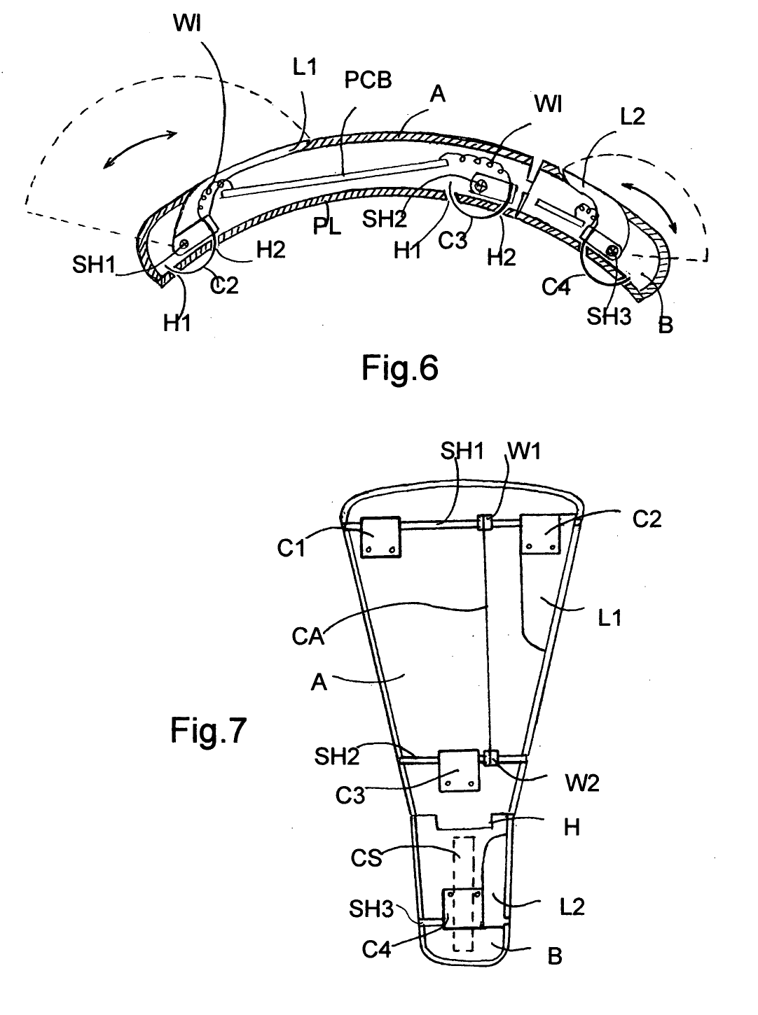

Referring to FIG. 6 and FIG. 7, lever L1 is fixed with shaft SH1 and claws pairs C1, C2. Wheel W1 is fixed on shaft SH1. Wheel W2 is fixed on shaft SH2. Shaft SH2 is fixed with claws pair C3. Shaft SH1 rotation is transmitted to shaft SH2 by wheel W1, a flexible rack or a cable CA and wheel W2. In the preferred embodiment I chose a cable CA. Lever L2 is fixed with shaft SH3 and pair of claws C3.

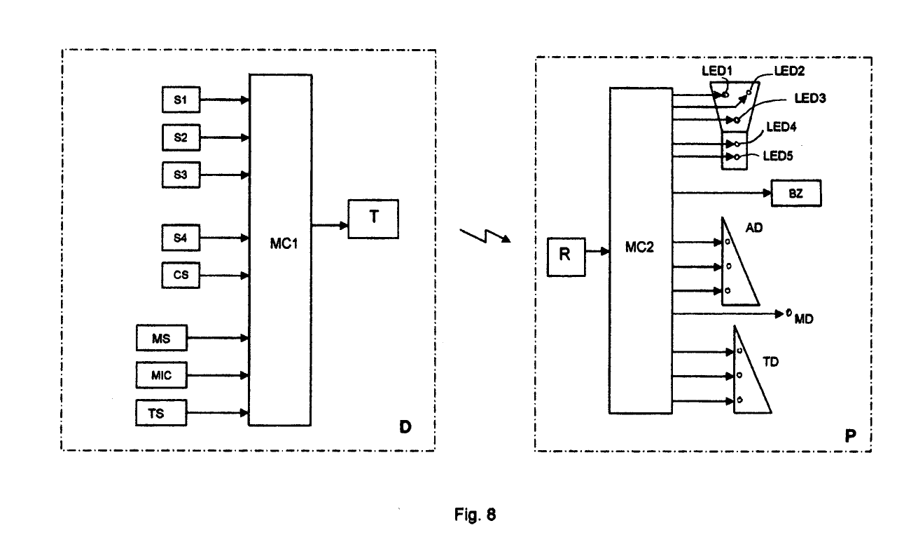

Referring to FIG. 8 and starting from upper left, conductive sensors S1 . . . S4 and capacitive sensor CS send their analog output to microcontroller MC1 analog to digital input ports. Said conductive sensors S1 . . . S4 are of usual type. Said capacitive sensor CS contains said transducer shown in FIG. 2 and the circuitry, which measures the voltage drop on said capacitive transducer. Said capacitive sensor transducer is a capacitor with both plates in the same plane and is supplied in high frequency power supply. By its software said MC1 analyzes the amplitude of each signal coming to its analog to digital input from said sensors. A signal is a pulse or a slow variation voltage. If any of said signals is bigger in amplitude than a predetermined value written in said MC1 software, said signal will go through said MC1. In this situation said sensors are considered activated. When the first said signal passes through said MC1, at the same moment said MC1 blocks/ignores for a predetermined period of time of approximately 1 minute all other signals coming from said sensors. That way detector D can detect which sensor was first activated and it makes the difference between urination and bowel movement. The attendant can see if the diaper bearer urinated or had a bowel movement. Because there are three urine sensors and two feces sensors placed conveniently on diaper surface, the attendant can see the diaper is full or partially full. The analog output from the microphone circuitry MIC enters another microcontroller MC1 analog to digital input. By its program MC1 analyzes said signals amplitudes and prepares them in three categories by three predetermined voltage levels.

First said category is for microphone small output level, second is for a medium level and third is for high level. Small level output corresponds to small audio level, third category corresponds to high audio level and so on.

A micro sensor for motion detection MS with mercury or electrolyte, installed on the detector D printed circuit board, sends its output to another analog to digital input of microcontroller MC1. Said microcontroller MC1, by its program, analyzes the number and frequency of pulses received from motion detector MS.

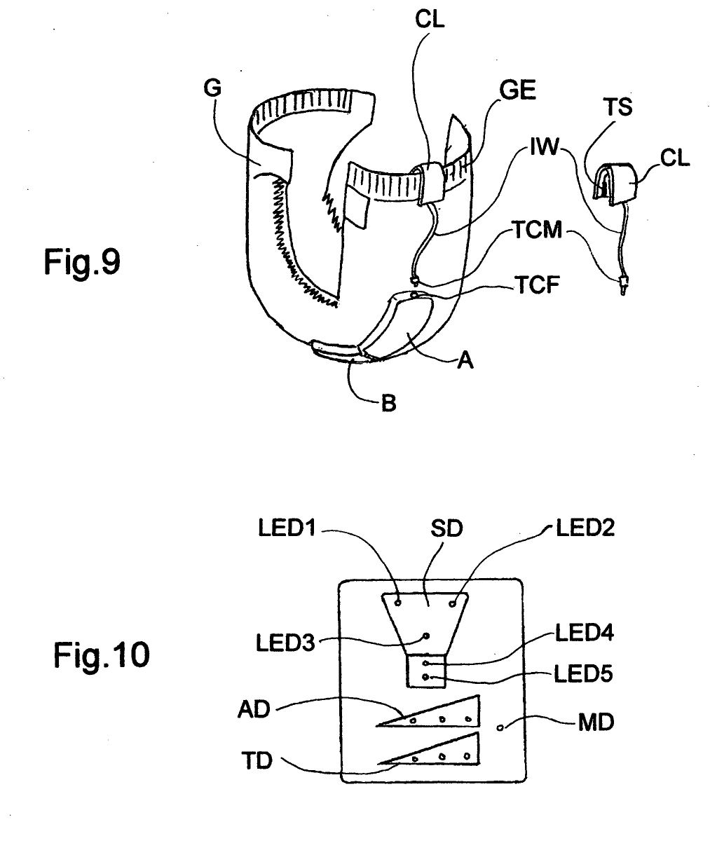

A detachable temperature sensor TS shown in FIG. 9 is attached to the detector D by an elastic clamp CL, the elastic insulated wire IW and a connector TCM. Being attached by clamp CL of diaper G belly elastic, the sensor TS is pressed against diaper wearer skin and its temperature read is accurate. When connector TCM is introduced in connector TCF connection between not shown temperature sensor and the measuring circuit TSC is interrupted and TS connects to TSC. TSC output enters MC1 analog to digital output. By its program, MC1 measures the amplitude of said output and divides it in three categories, as MIC output. The use of said temperature sensor is optional.

MC1 encodes and serializes said signals/pulses coming from each and all sensors, MS, MIC and TS and send them to a RF transmitter T.

A RF receiver R receives encoded trains of pulses and sends them to a microcontroller MC2 digital input. MC2 decodes and outputs pulses as is written in its program. LED1 . . . LED4 flash when S1 . . . S4 are activated. LED5 flashes when CS is activated. Any of S1 . . . S4, CS sensors is considered activated when said sensor output exceeds the predetermined value, written in MC1 program. By its program MC2 beeps buzzer BZ when S4 and/or CS are activated or when all S1...S4 are activated.

By its program MC2 flashes led MD and beeps buzzer BZ if motion sensor MS is activated, as well as no activation occurred for 20 seconds time.

By its program MC2 flashes led-s of audio display AD corresponding to activation levels of MIC. MC2, by its program, beeps buzzer BZ when sound amplitude comes to medium level.

By its program MC2 flashes led-s of temperature display TD corresponding to activation levels of TS. MC2, by its program, beeps buzzer BZ when diaper bearer temperature value exceeds normal level.

In order that power consumption to be maintained at a minimum level the detector D is power supplied only when claws are out of detector D case, in running position. That is easily achieved with a micro switch connected mechanically with lever L1 movement. Micro switch turns the power on, when lever L1 is in position shown in FIG. 6. Said switch turns power off when lever L1 is in a position rotated 150 degrees, with claws retracted in reposed position, as shown in FIG. 4.

Referring additionally now to FIG. 10, miniature size luminescent diodes LED1 . . . LED3 flash in relation to wetness urine sensors S1 . . . S3. One or both diodes LED4 and LED5 flash when feces have activated one or both sensors S4 and CS. Luminescent diodes, comprised in audio display AD flash in relation to the noise level received by microphone MC. Diode MD flashes in relation with motion sensor MD. Luminescent diodes, comprised in temperature display TD flash in relation to the diaper wearer body temperature level received by temperature sensor TS.

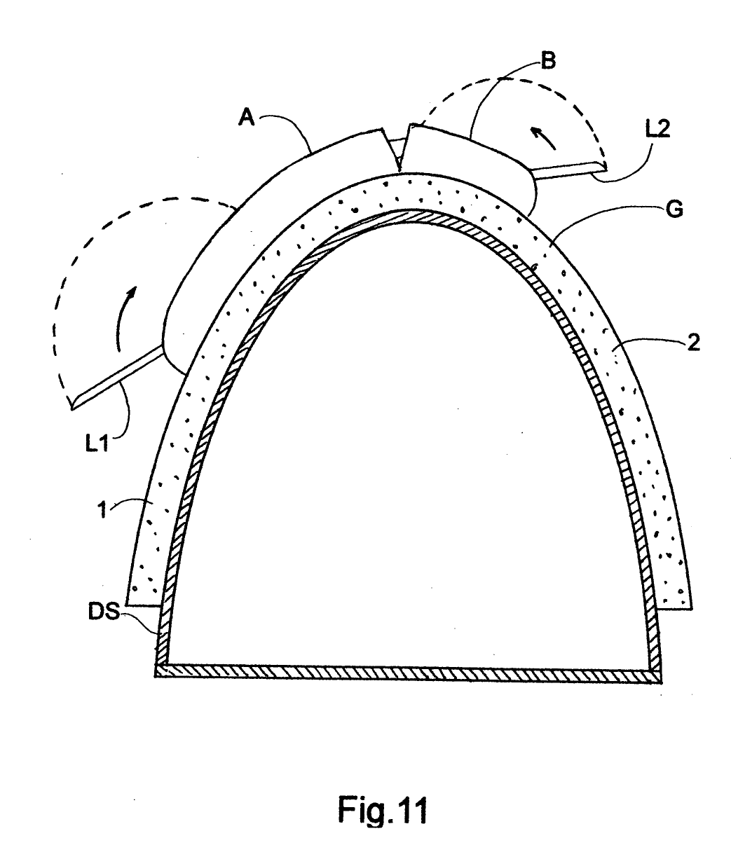

Operation-FIG. 11

Referring additionally now to FIG. 11, the attendant sets up cloth or paper diaper G on top of diaper support DS in position shown. Then said attendant sets up the detector D on top of the diaper G on its longitudinal axis, in position shown in FIG. 11, part A on diaper G front side and part B on diaper G back side. Then attendant, holding pressed the detector D on diaper G, rotates lever L1 from left to right and lever L2 from right to left. That way the claws come out from detector case, go through the diaper and come out from said diaper to enter back into said detector case through each hole H2 corresponding to each claw. Now the detector is affixed on diaper and diaper can be dressed on the diaper bearer. The size, shape and weight of detector D help the diaper bearer to feel comfortable like there is nothing affixed on it. Pager is so small it can be the size of a wristwatch. It depends on electronics size. In order to be comfortable in use, detector D must be as lightweight as possible and to follow the shape of the diaper. The lightness is achieved by its small, plastic body, small electronics and a very small rechargeable battery. When not in use detector and pager seats in a support/charger as any rechargeable computer mouse.

The device monitors all the parameters a parent needs to monitor to her or his baby, or, an attendant needs to monitor on any patient.

1. An apparatus for use with a diaper to detect:
Urine and feces presence;
Distinction between urine and feces in said diaper;
Fullness level of urine and feces in said diaper;
Said diaper wearer motion and stillness;
Said diaper wearer sound;
Said diaper wearer temperature.
And to produce an electrical output in response to such detection, said apparatus comprising:
A plurality of retractable claws pairs serving to affix or detach said apparatus of said diaper and also serving as electrodes for conductive type sensors;
A housing for containing electronic components, the back of said housing being retainable against the exterior surface of said diaper;
A multitude of urine conductive sensors located within said housing and a multitude of feces sensors, some of them conductive type and the other capacitive type;
Electronic circuitry within said housing responsive to said sensors for producing an output signal when output of said sensors reaches a predetermined value.

2. The apparatus of claim 1 wherein said sensors output are provided to a transmitter for transmitting one or more alarm signals in the presence of one ore more said diaper conditions.

3. A pager for remotely monitoring said diaper conditions

4. A system for remotely monitoring said diaper conditions, said system comprising:
a plurality of said apparatuses, whereby each of said apparatuses is affixed to a diaper to be monitored, each said apparatuses are electronically encoded with an address, said apparatus's sensors output and said address are provided to said transmitter;
at least one receiver for receiving said encoded signals and addresses; and
at least one pager receiving from said receiver signals about said diaper conditions.
